(19) United States
(12) Patent Application Publication
(10) Pub. No.: US 2019/0286387 A1
(43) Pub. Date: Sep. 19, 2019

(54) SYSTEM AND METHOD FOR INTERRUPTING PRINT JOBS BASED ON PRINTED IMAGE QUALITY

(71) Applicants: Kabushiki Kaisha Toshiba, Minato-ku (JP); Toshiba TEC Kabushiki Kaisha, Shinagawa-ku (JP)

(72) Inventor: Jeffrey WONG, Aliso Viejo, CA (US)

(21) Appl. No.: 15/923,355

(22) Filed: Mar. 16, 2018

(51) Int. Cl. G06F 3/12

(52) U.S. Cl. CPC G06F 3/1219; G06F 3/1226; G06F 3/1275

(57) ABSTRACT

A system and method for interrupting printing of low quality documents includes an MFP having an intelligent controller including a processor and associated memory, and scan and print engines operable in conjunction with instructions issued from the controller. A network interface receives print job data from an associated device and stores it in memory along with print quality rule data corresponding to acceptable print job output appearance parameters. The controller commences a print of received print job data and a scan of printed print job data. The controller selectively aborts printing of the print job data in accordance with the scan data and the print quality rule data.

### TECHNICAL FIELD

This application relates generally to print quality assurance for print jobs. The application relates more particularly to a printout and scan of a print job page to assess print quality prior to completing a print job.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

Users may have their own printer directly attached to their computer or other digital device for printing. Given the expense in obtaining and maintain more capable MFPs, these devices are frequently shared among networked users. By way of example, a user sends their print job to the MFP from their office computer, and their print job is queued and printed. A user will then walk to that MFP, which might not be close to their office, to retrieve their printout. If there is a problem with the MFP printer, such as low toner, the resultant printout may be unacceptable, or even illegible. The user will then need to return to their office and resubmit their print job to a different device, or the same device once the error condition has been addressed. The user must then go to the designated MFP and retrieve their reprinted job.

The common situation noted above has a substantial cost in wasted paper, wasted electricity, wasted toner or ink, additional mechanical wear on the device and a significant waste of human resource time. Additionally, many businesses today do not purchase MFPs, but lease them from a distributor. Cost to the business may be based on a number of printed pages. In this situation, the business is paying for extra pages for each duplicated print job.

### SUMMARY

In accordance with an example embodiment of the subject application, a system and method for interrupting printing of low quality documents includes an MFP having an intelligent controller including a processor and associated memory, and scan and print engines operable in conjunction with instructions issued from the controller. A network interface receives print job data from an associated device and stores it in memory along with print quality rule data corresponding to acceptable print job output appearance parameters. The controller commences a print of received print job data and a scan of printed print job data. The controller selectively aborts printing of the print job data in accordance with the scan data and the print quality rule data.

### BRIEF DESCRIPTION OF THE DRAWINGS

Various embodiments will become better understood with regard to the following description, appended claims and accompanying drawings wherein:

FIG. 1 an example embodiment of a document processing system that interrupts printing of a multipage document when image quality is unacceptable;

FIG. 2 is an example embodiment of a networked digital device, such as a multifunction peripheral;

FIG. 3 is a flowchart of an example embodiment of a system for interrupting print jobs with renderings of insufficient quality; and

FIG. 4 is an example embodiment of a page quality test scenario.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

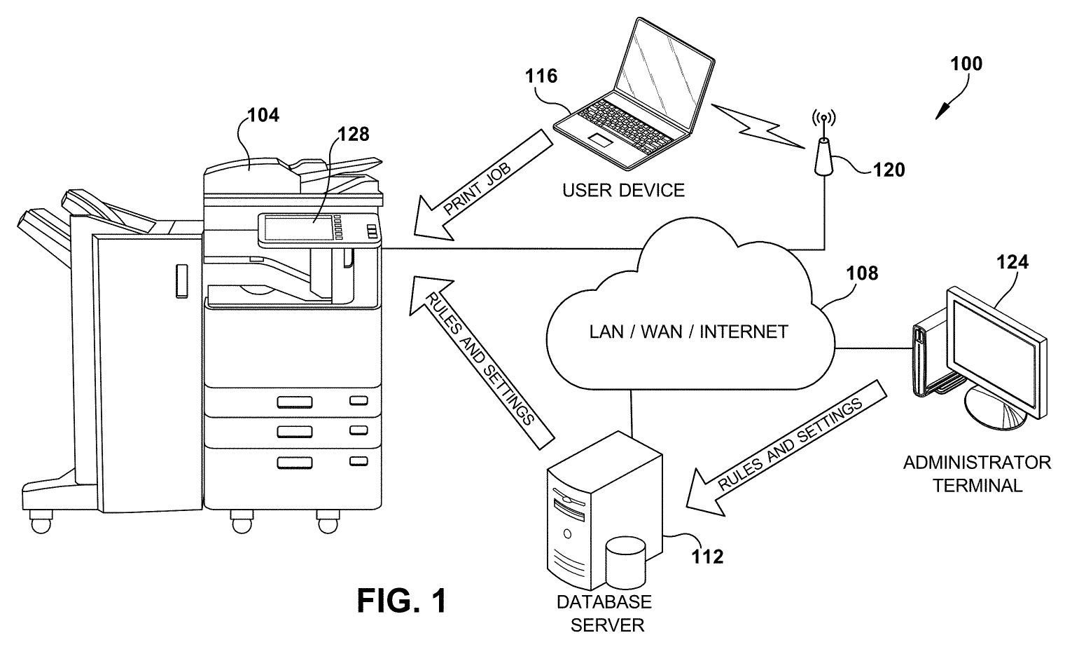

In accordance with the subject application, FIG. 1 illustrates an example embodiment of a document processing system 100 that interrupts printing of a multipage document when image quality is unacceptable, such as when one or more colors of toner or ink are depleted or some other printing error adversely affects a printed image. Other example factors that may impact image quality include faulty paper stock, printer registration errors, improper paper feeds, poor environmental conditions, damaged photoconductive drums or electrostatic process units, and the like. In the illustrated example, MFP 104 is connected with networked digital devices via network cloud 108, suitably comprised of a local area network (LAN), a wide area network (WAN) which may comprise the global Internet, or any suitable combination thereof. Connection with network cloud 108 is via any suitable wired connection or wireless connection. Networked devices include database server 112 and one or more user devices 116, suitably a desktop computer, notebook computer, tablet computer, smartphone, or any other suitable digital device. In the illustrated example, user device 116 is comprised of a notebook computer in wireless data communication with network cloud 108 via Wi-Fi access point 120.

Also connected to cloud 108 is an administrative terminal 124 that provides rules and settings for MFP 104 as to what constitutes an acceptable image. Such rules and settings are suitably stored in database server 112 for ease in distribution to multiple MFPs, such as MFP 104. As will be further detailed below, a user suitably submits a print job from user device 116 to MFP 104 via cloud 108. MFP 104 commences printing of the user's job. Early renderings in a multipage print job, such as page one, are scanned and an electronic scan document is formed. Printing of subsequent pages is suspended while the initial page print is analyzed. Such analysis is suitably completed on any digital computing device, such as via an intelligent controller in MFP 104. The electronic scan document is analyzed relative to rules and settings received from database server 112. If it is determined that the printed page does not conform to specified standards, further printing of pages is suspended or cancelled and the user sending the job is notified. Such notification can be via electronic message to user device 116, via MFP display 128, or both.

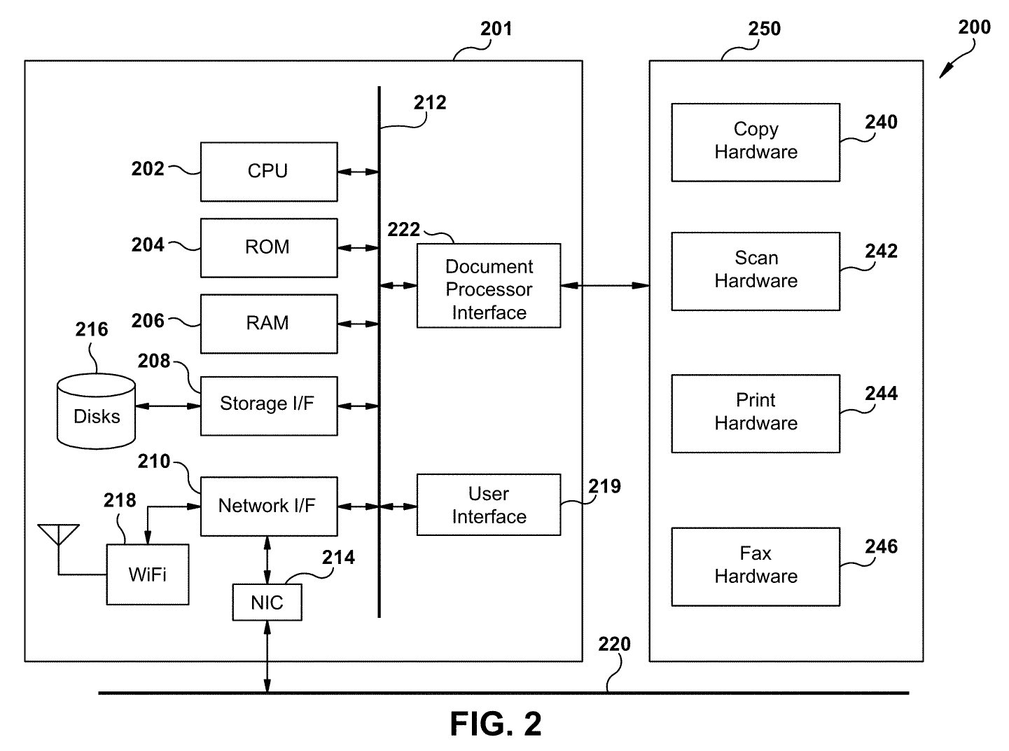

Turning now to FIG. 2 illustrated is an example embodiment of a networked digital device comprised of document rendering system 200 suitably comprised within an MFP, such as with MFP 104 of FIG. 1. Included in controller 201 are one or more processors, such as that illustrated by processor 202. Each processor is suitably associated with non-volatile memory, such as ROM 204, and random access memory (RAM) 206, via a data bus 212.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection 220, or to a wireless data connection via wireless network interface 218. Example wireless connections include cellular, Wi-Fi, Bluetooth, NFC, wireless universal serial bus (wireless USB), satellite, and the like. Example wired interfaces include Ethernet, USB, IEEE 1394 (FireWire), Apple Lightning, telephone line, or the like. Processor 202 is also in data communication with one or more sensors which provide data relative to a state of the device or associated surroundings, such as device temperature, ambient temperature, humidity, device movement and the like.

Processor 202 can also be in data communication with any suitable user input/output (I/O) interface 219 which provides data communication with user peripherals, such as displays, keyboards, mice, track balls, touch screens, or the like. Hardware monitors suitably provide device event data, working in concert with suitable monitoring systems. By way of further example, monitoring systems may capture page counters, sensor output, such as consumable level sensors, temperature sensors, power quality sensors, device error sensors, door open sensors, and the like. Data is suitably stored in one or more device logs, such as in storage 216 of FIG. 2.

Also in data communication with data bus 212 is a document processor interface 222 suitable for data communication with MFP functional units. In the illustrated example, these units include copy hardware 240, scan hardware 242, print hardware 244 and fax hardware 246 which together comprise MFP functional hardware 250. It will be understood that functional units are suitably comprised of intelligent units, including any suitable hardware or software platform.

Controller 201 is suitably provided with an embedded web server system for device configuration and administration. A suitable web interface is comprised of TOPACCESS Controller (sometimes referred to in the subject illustrations as “TA”), available from Toshiba TEC Corporation.

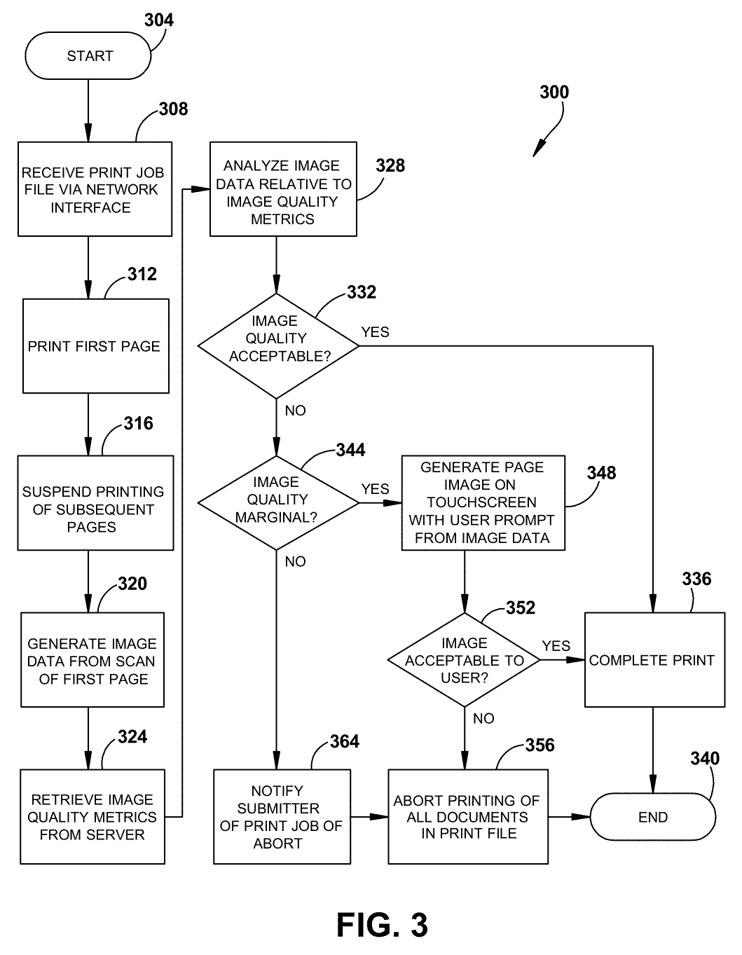

FIG. 3 is a flowchart 300 of an example embodiment of a system for interrupting print jobs with renderings of insufficient quality. The process commences at block 304 and a print file is received via a network interface at block 308. An initial portion of the print file, such as a first page, is printed at block 312 and printing of subsequent pages suspended at block 316. A scan of the first page is made at block 320 and image quality metrics, such as rules and settings detailed in FIG. 1, are retrieved from a database server at block 324. The electronic scan file from the printed first page is analyzed relative to the image quality metrics at block 328. If a determination is made at block 332 that the image metrics are satisfied, printing is resumed and completed at block 336, after which the process suitably terminates at block 340.

If image quality is determined to be unacceptable at block 332, quality may nonetheless be acceptable to a particular user, such as when the printout is a preliminary draft. A test to determine whether image quality is marginal, but potentially acceptable to the user submitting the job, is made at block 344. If the higher standards of block 332 are not met, a lower acceptability threshold test is made at block 344. If the image does not meet the lower acceptability threshold at block 344, the user is notified that the print job has been aborted at block 364, and printing of the remaining pages is aborted at block 356 before the process ends at block 340. If the image falls within the two levels, the printed page is fed to the user to revie bw, or an image of the printed page sent to the user device or MFP display at block 348. A prompt is generated to the user to determine whether it is acceptable and the user responds accordingly. If the image is acceptable to the user as determined at block 352, the process proceeds to block 336 to complete the print. If not, printing of the remaining pages is aborted at block 356 before the process ends at block 340.

If the lower standards of marginality are not achieved at block 344, the user is notified of an aborted print at block 364 and the process proceeds to block 356 to abort the print before ending at block 340.

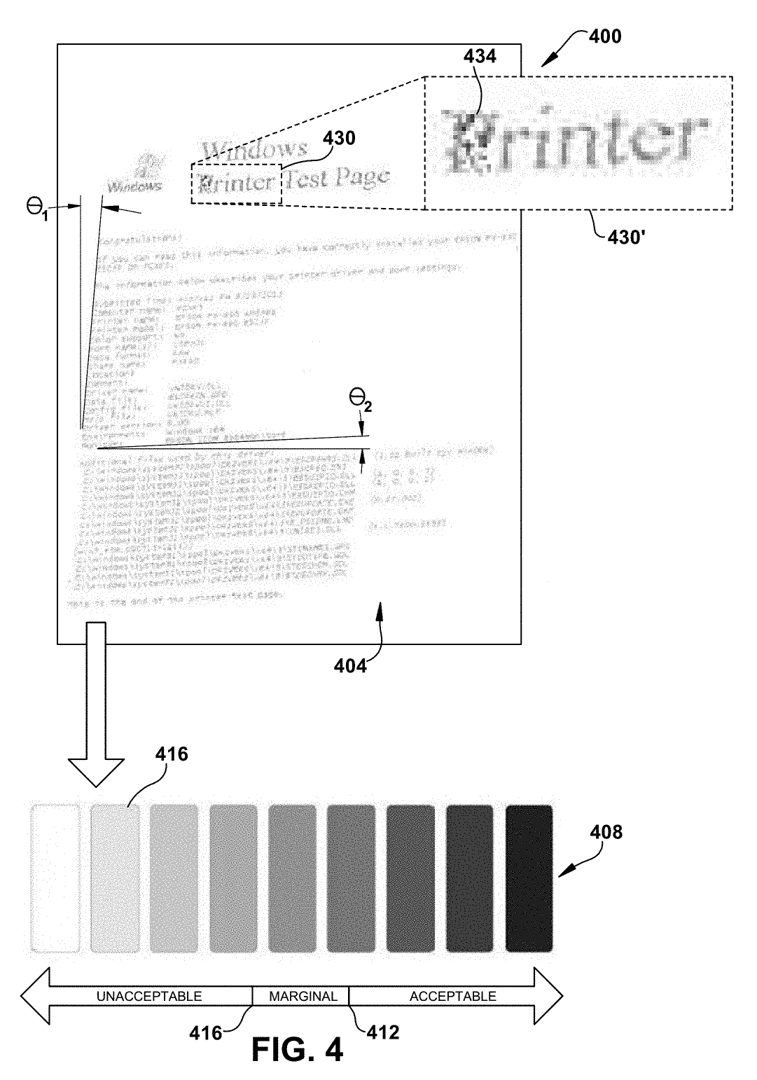

FIG. 4 is an example embodiment of a page quality test scenario 400 wherein printed page 404 is printed and scanned. A test is suitably made for image contrast, such as via a comparison with grayscale 408 for which an acceptability threshold 412 and a marginal threshold 416 have been set. Text of document 404 is determined to be at a grayscale 408 level which is deemed unacceptable. Other conditions determine acceptability may be relative to a vertical skew angle θ₁ or a horizontal skew angle θ₂. Character data can also be used to determine acceptability, such as character block 430, magnified at 430′, which contains garbled character 434.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

1. A system comprising:
an intelligent controller including a processor and associated memory;
a scan engine operable in conjunction with instructions issued from the controller;
a print engine operable in conjunction with instructions issued from the controller; and
a network interface configured to receive print job data from an associated device,
wherein the memory is configured to store print quality rule data corresponding to acceptable print job output appearance parameters,
wherein the controller is configured to commence a print of received print job data by the print engine,
wherein the controller is further configured to commence a scan of printed print job data by the scan engine,
wherein the controller is further configured to receive electronic scan data corresponding to the scan from the scan engine, and
wherein the controller is further configured to selectively abort printing of the print job data in accordance with the scan data and the print quality rule data.

2. The system of claim 1 wherein the controller is further configured to generate a notification when printing of the print job data is aborted.

3. The system of claim 1 wherein the controller is further configured to retrieve the print quality rule data from an associated server via the network interface.

4. The system of claim 1 wherein the print quality rule data includes data corresponding to acceptable toner levels indicated by the print job scan data.

5. The system of claim 1 wherein the electronic scan data is comprised of a first printed page of the print job data.

6. The system of claim 1 wherein the print quality rule data includes data corresponding to unreadable characters indicated by the print job scan data.

7. The system of claim 1 wherein the print job data includes an instruction to generate duplicate printouts therefrom, and wherein the controller is further configured to further abort printing of duplicate printouts.

8. A method comprising:
receiving a plurality of print job data sets from at least one associated device into an intelligent controller of a multifunction peripheral via a network interface;
retrieving from a memory stored print quality rule data corresponding to acceptable print job output appearance parameters;
commencing a print of each received print job data set in accordance with an instruction issued by the controller;
commencing a scan of each printed print job data set in accordance with an instruction issued by the controller;
receiving an electronic scan data set corresponding to each scan into the controller; and
selectively abort printing of each print job data set in accordance with its corresponding scan data set and the print quality rule data in accordance with an instruction issued by the controller.

9. The method of claim 8 wherein the controller is further configured to generate a notification when printing is aborted.

10. The method of claim 8 wherein the controller is further configured to retrieve the print quality rule data from an associated server via the network interface.

11. The method of claim 8 wherein the print quality rule data includes data corresponding to acceptable text skew indicated by characters encoded in a print job scan data set.

12. The method of claim 8 wherein the electronic scan data is comprised of a first printed page of the print job data.

13. The method of claim 8 wherein the print quality rule data includes data corresponding to unreadable characters indicated by the print job scan data.

14. The method of claim 8 wherein the print job data includes an instruction to generate duplicate printouts therefrom, and wherein the controller is further configured to further abort printing of duplicate printouts.

15. A system comprising:
an intelligent controller including a processor and associated memory;
a user interface including a user input and a display;
a scan engine operable in conjunction with instructions issued from the controller;
a print engine operable in conjunction with instructions issued from the controller; and
a network interface configured to receive print job data from an associated device,
wherein the memory is configured to store preselected print quality rule data corresponding to acceptable print job output appearance parameters for each of a plurality of print jobs,
wherein the controller is configured to instruct the print engine to print a first page of an electronic document encoded in received print job data,
wherein the controller is further configured instruct the scan engine to scan the first page to generate electronic image data,
wherein memory is further configured to store electronic image data corresponding to the scan,
wherein the controller is further configured to selectively suspend printing of the print job data in accordance with the scan data and the print quality rule data, and
wherein the controller is further configured to generate a prompt on the display corresponding to a suspended print job.

16. The system of claim 15 the controller is further configured to print or abort the suspended print job in accordance with user input received via the user interface responsive to the prompt.

17. The system of claim 16 the controller is further configured to provide an image of the first page to a user in conjunction with a generated prompt.

18. The system of claim 17 wherein the first page image is comprised of the printed first page.

19. The system of claim 17 wherein the first page image is generated on the display by the controller.

20. The system of claim 17 wherein the controller is further configured to communicate the first page image to the associated device via the network interface.
